(19) United States
(12) Patent Application Publication
(10) Pub. No.: US 2017/0214304 A1
(43) Pub. Date: Jul. 27, 2017

(54) MULTIPLE ALTERNATING CURRENT GENERATOR

(71) Applicant: Chul Kon KIM, Anyang-si, Gyeonggi-do (KR)

(72) Inventor: Chul Kon KIM, Anyang-si, Gyeonggi-do (KR)

(21) Appl. No.: 15/328,488

(22) PCT Filed: Jul. 21, 2015
(86) PCT No.: PCT/KR2015/007537

§ 371 Date: Feb. 22, 2017

(30) Foreign Application Priority Data
Jul. 29, 2014 (KR) 10-2014-0096384
Jun. 15, 2015 (KR) 10-2015-0084507

(51) Int. Cl. H02K 16/00; H02K 13/00; H02K 9/06; H02K 5/04

(52) U.S. Cl. CPC H02K 16/00; H02K 5/04; H02K 13/003; H02K 9/06

(57) ABSTRACT

Disclosed is a multiple alternating current generator comprising: a rotating shaft; a plurality of rotators coupled about the rotating shaft so as to be able to rotate together with the rotating shaft; a plurality of stators formed in cylindrical-shapes so as to surround the rotors, a plurality of coil winding units being formed on the inner peripheral surfaces of the stators such that coils are wound, respectively, and the outer peripheral surfaces of the stators being coupled to a housing; a housing of a cylindrical shape comprising a plurality of stator coupling grooves, in which the plurality of stators can be arranged, and intermediate support unit grooves, on which a plurality of intermediate support units can be arranged; and intermediate support units, which are coupled to the intermediate support unit grooves, and which have bearings for supporting the rotating shaft between the plurality of rotors.

### TECHNICAL FIELD

The present invention relates to a multiple alternating current generator in which a plurality of rotators are coupled to a single central rotating shaft inside a housing provided with upper and lower housings, a plurality of stators that surround the plurality of rotators are coupled to the housing, intermediate support units between the rotators are allowed to be detached from and attached to the rotators, and the housing is allowed to opened and closed vertically, thereby manufacturing and maintenance are facilitated and small and light units is manufactured.

### BACKGROUND ART

In a conventional multiple alternating current generator technology such as that in literature 1 (Japanese Patent Publication No. 3960360), a multiple rotation apparatus is formed with a plurality of rotating apparatuses that have serially coupled rotation shafts and are used as generators or motors, wherein each of the rotating apparatuses includes a rotating shaft, an electromagnetic coil, a permanent magnet, and a housing as shown in FIG. 7. In the configuration of the conventional multiple rotation apparatus, because multiple generation is achieved by having a stator and a rotator couple to a cylindrical housing and linearly coupling the rotation shafts of a plurality of such rotating apparatuses that are coupled to bearings on both sides of each thereof, there are technical difficulties including having increased mounting space, difficult assembly, having high manufacturing cost because a plurality of housings have to be each manufactured, and having to separately mount the generators and align along the rotation shafts, etc. Also, a multiple alternating current generator submitted as a patent application (Patent No. 10-2014-0096384, application on Jul. 29, 2014) by the applicant of the present patent application has integrated intermediate support units inside a housing that cause technical difficulties related to methods of manufacturing the housings via a casting method such as a die casting method or the like and high cost.

### DISCLOSURE

1. Japanese Patent Publication No. 3960360 (May 25, 2007)
2. Korean Patent Registration No. 10-1312792
3. Korean Laid-open Patent Registration No. 10-0339467 (Oct. 25, 2002)
4. Korean Patent No. Registration No. 10-0189332 (Jun. 1, 1999)

### TECHNICAL PROBLEM

The present invention is directed to providing a small and light multiple alternating current generator that has multiple rotators and stators inside a single housing, are thus easily manufactured, and may lead to reduced manufacturing cost due to a reduced number of housings rather than having linearly connected rotation shafts of a plurality of generators as in a conventional multiple alternating current generator.

Also, whereas a conventional housing structure leads to difficulties in assembly or disassembly from either side of the cylindrical housing because the rotator and the stator are coupled to the cylindrical housing, the present invention is directed to providing a multiple alternating current generator with facilitated assembly or maintenance by vertical coupling of upper and lower semi-cylindrical housings to form a cylindrically shaped housing that allows opening of the upper housing.

The present invention is also directed to providing a multiple alternating current generator with facilitated manufacturing due to having a structure in which intermediate support units are detachable from the upper and lower housings, in order to solve the difficulties of the conventional manufacturing arising from a casting method such as a die casting method or the like due to the intermediate support units that support a rotating shaft being integrally formed with the housing.

### TECHNICAL SOLUTION

One aspect of the present invention provides a multiple alternating current generator includes a rotating shaft, a plurality of rotators coupled to the rotating shaft about the rotating shaft to allow rotating with the rotating shaft, a plurality of stators formed in a cylindrical shape surrounding each of the rotators, having an inner circumferential surface on which a plurality of coil windings are formed, and having an outer circumferential surface coupled to a housing, the housing in a cylindrical shape provided with a plurality of stator coupling grooves configured to arrange a plurality of stators therein, and intermediate support unit grooves configured to arrange a plurality of intermediate support units, wherein the housing includes bearings configured to support the rotating shaft at both sides, and intermediate support units coupled to the intermediate support unit grooves and having bearings that support the rotating shaft between the plurality of rotators.

The housing may be formed in a cylindrical shape with semi-cylindrically shaped upper and lower housings coupled with each other and has a structure in which the upper housing separated by opening upward. The upper and lower housings may have stator grooves and intermediate support unit grooves having widths that are the same as widths of the stator and the intermediate support unit on an inner circumferential surface of the housing so that the stator and the intermediate support units inside each of the upper and lower housings may be stably coupled, thus facilitating assembly and maintenance.

The rotating shaft may have a structure with one rotating shaft or a plurality of individual rotating shafts that are coupled to be assembled, and the assembled structure may have a structure in which the rotating shafts are inserted into both sides of a pipe-shaped rotating shaft connection member and connection member and the rotating shaft are fixed with headless bolts.

The magnetic poles of the rotators may be arranged such that the same poles of the adjacent rotators are symmetrically arranged to face each other about the intermediate support unit in order to prevent cancelling of magnetic flux between the adjacent rotators, and the polarities of each electromagnet are arranged symmetrically in a line.

In order to increase a cooling effect of the generator, a fan may be attached to a side of a metal core of the rotator to force air to circulate from a front vent to a rear vent, and a plurality of vents may be provided on an outer circumferential surface of the cylindrical housing at locations coincident with the fans attached to the rotator, at both sides of the housing, and at intermediate support units in order to increase the cooling effect.

A power supply unit for supplying a current to the rotator may supply a current to a coil of the rotator from an external battery or through a rectifier by coupling a power control unit that has a pair of brush and slip ring to a rear bearing support unit of the housing or by feeding a portion of a generated voltage back to the power supply unit through an output terminal attached to an outer circumferential surface of the lower housing, through which a voltage generated from the coil of the stator is output.

### ADVANTAGEOUS EFFECTS

In the present invention, a multiple alternating current generator in which a plurality of generator units are provided inside a single housing, rather than having linearly connected rotating shafts of a plurality of generators as in a conventional alternating current generator to multiply generate power, has the following advantageous effects.

First, by coupling semi-cylindrical shape upper and lower housings into a cylindrically shaped housing with the upper housing that can be opened, the present invention solves the difficulties arising from coupling a stator and a rotator to a conventional cylindrically shaped housing and assembling or disassembling on either side of the cylindrical housing, thus significantly facilitating assembly or maintenance.

Second, by having a structure in which an intermediate bearing unit is detachable from the upper and lower housings, the present invention solves the manufacturing difficulties arising from the housing and the intermediate support units having an integrated structure, thus facilitating maintenance.

Third, there is a superior cooling effect due to having a plurality of vents on the outer circumferential surface and on both sides of the housing which are located on a straight line formed with the rotator fan and the stator coil of each generator unit.

Fourth, there is an advantage in which an output voltage of each generator may easily be differentiated, selected, and used according to a load voltage.

### DESCRIPTION OF DRAWINGS

FIG. 1 is a front view of the assembled exterior of a multiple alternating current generator according to the present invention.

FIG. 2 is a cross-sectional view of the multiple alternating current generator in FIG. 1 according to the present invention.

FIG. 3 is a view of an example of a plurality rotating shafts of the multiple alternating current generator according to the present invention.

FIG. 4 is a view of a polarity arrangement of rotators of the multiple alternating current generator according to the present invention.

FIG. 5 is a coupling structure between a housing and intermediate support units of the multiple alternating current generator according to the present invention.

FIG. 6 is a separated structure of the housing and the intermediate support units of the multiple alternating current generator according to the present invention.

FIG. 7 is a view of an example shape of a rotator metal core used in the multiple alternating current generator of the present invention.

FIG. 8 shows an exterior appearance of a coupling structure of a conventional multiple rotator apparatus.

### BEST MODE

A multiple alternating current generator according to the present invention includes a rotating shaft, a plurality of rotators coupled to the rotating shaft at the center to allow rotating with the rotating shaft, a plurality of stators formed in a cylindrical shape surrounding the rotator, on the inner circumferential surface of which a plurality of coil windings are formed, and the outer circumferential surface of which is coupled to a housing, a housing in a cylindrical shape that includes a plurality of stator coupling grooves configured to arrange a plurality of stators therein, an intermediate support unit groove configured to arrange a plurality of intermediate support units and including bearings in both directions that support the rotating shaft, and intermediate support units coupled to the intermediate support unit groove and having bearings that support the rotating shaft between the plurality of rotators.

### MODES OF THE INVENTION

For fully understanding the present invention, exemplary embodiments of the present invention are described with references to the accompanying drawings. The present invention may be embodied in different forms and should not be construed as being limited to the embodiments described below in detail. The embodiments are provided in order to more fully describe the present invention to those skilled in the art. Accordingly, forms, shapes, and the like of components in the drawings may be exaggerated for emphasizing clarity in the descriptions. It should be noted that the same reference numerals may indicate the same components throughout the specification. In addition, detailed descriptions of well-known functions or configurations deemed to unnecessarily obscure the subject matters of the invention are omitted.

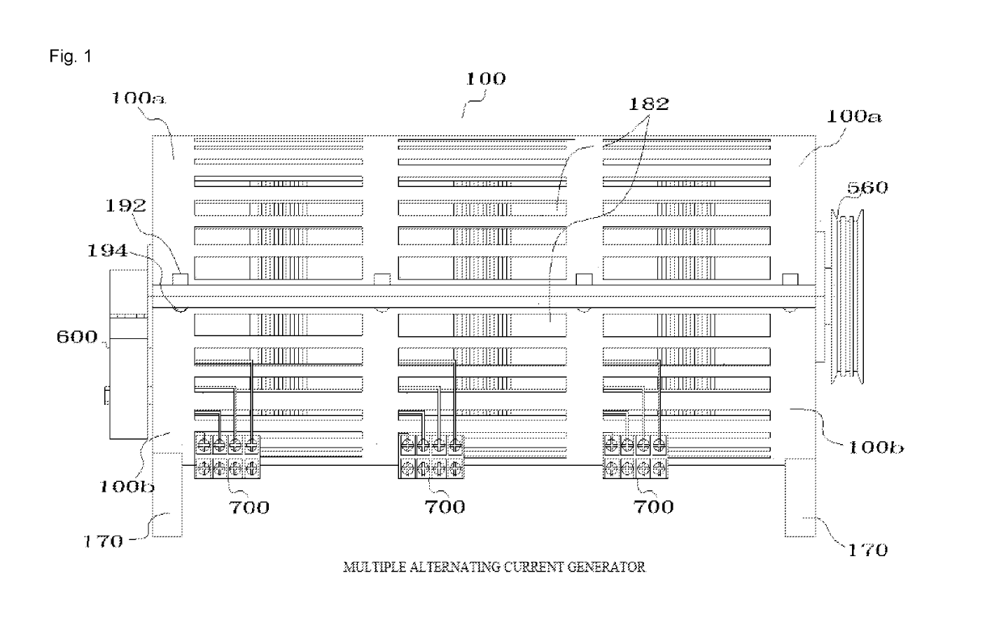

Hereinafter, a multiple alternating current generator according to the present invention is described with references to FIGS. 1 to 6. Whereas a multiple alternating current generator configured with 3 generator units is described in the embodiment, the multiple alternating current generator may include a plurality of generator units that are two or four or more but limited to 10 generator units or less. Hereinafter, the numbers of intermediate support units, stator metal cores, rotator metal cores, etc. related to the plurality of generator units are each 10 or less.

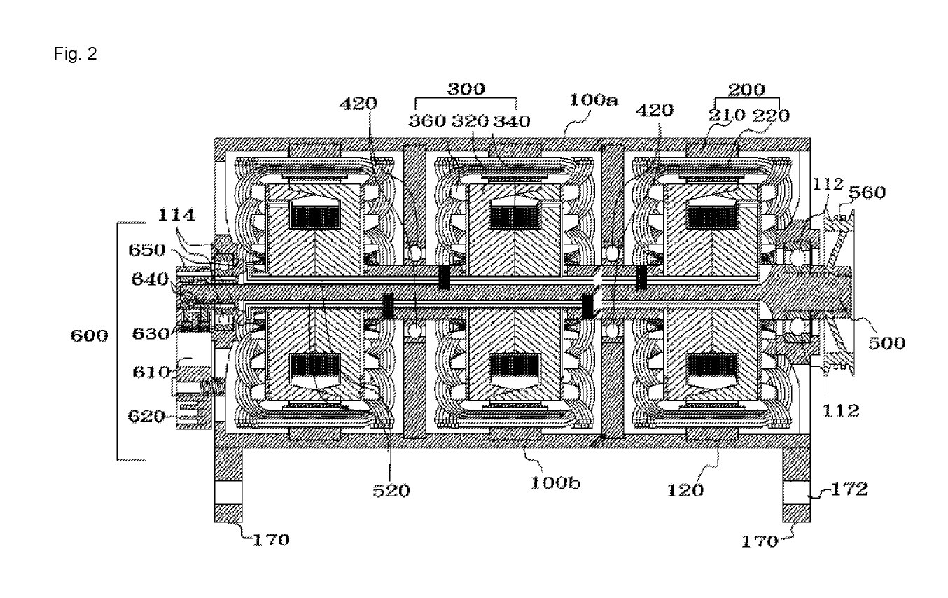

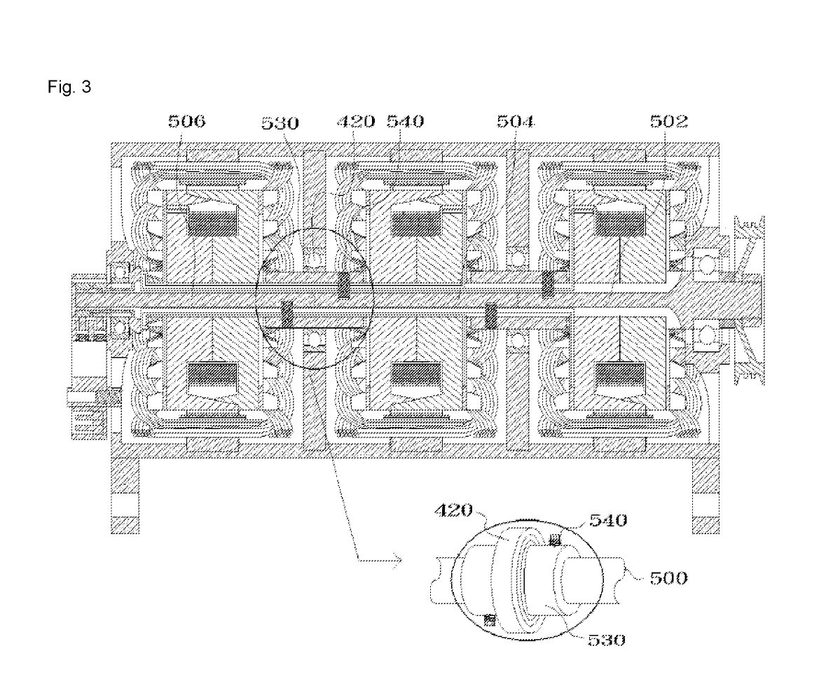

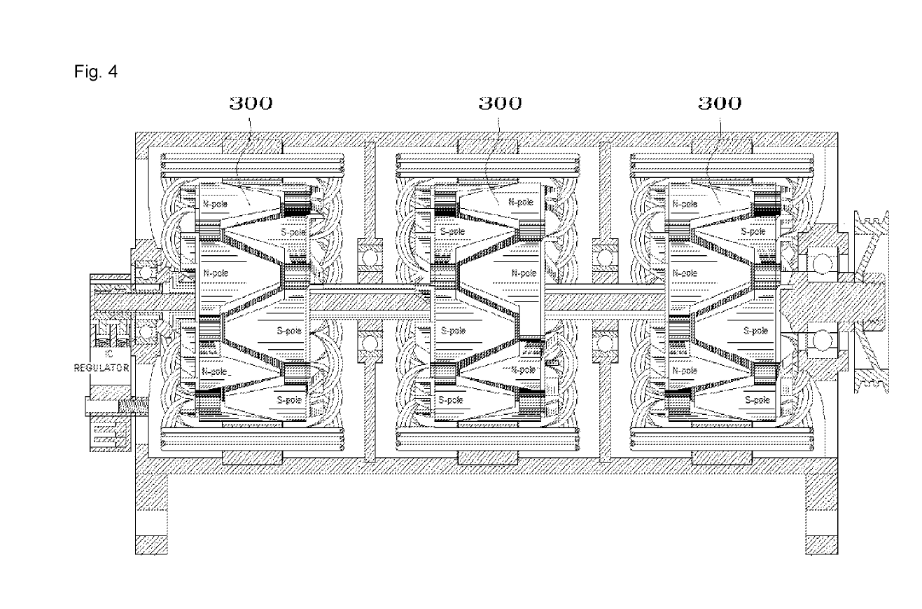

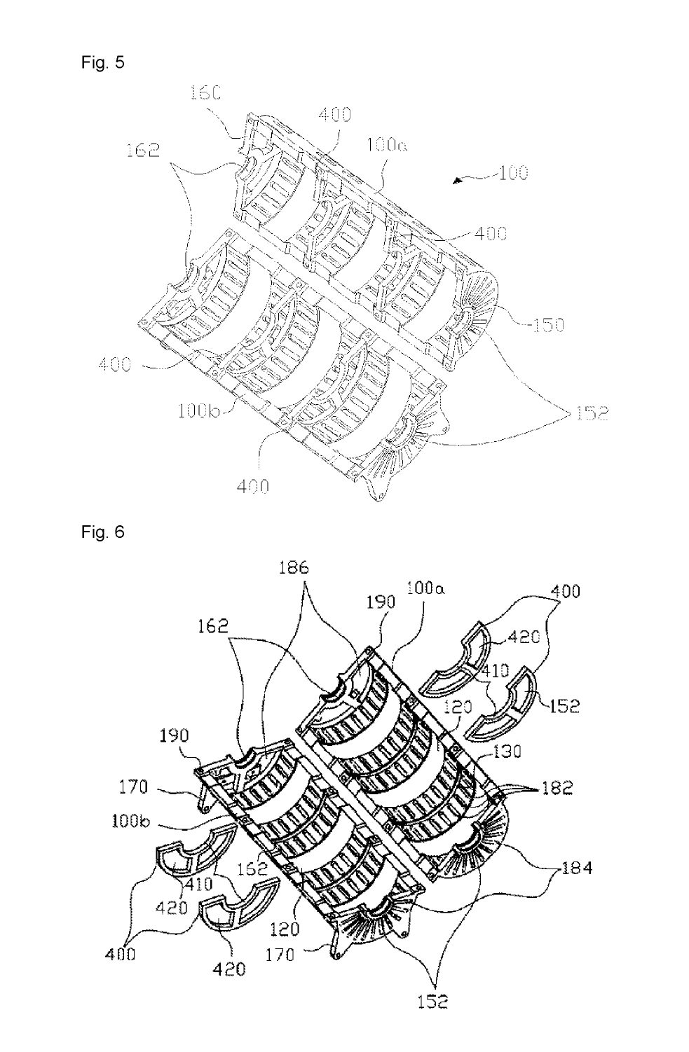

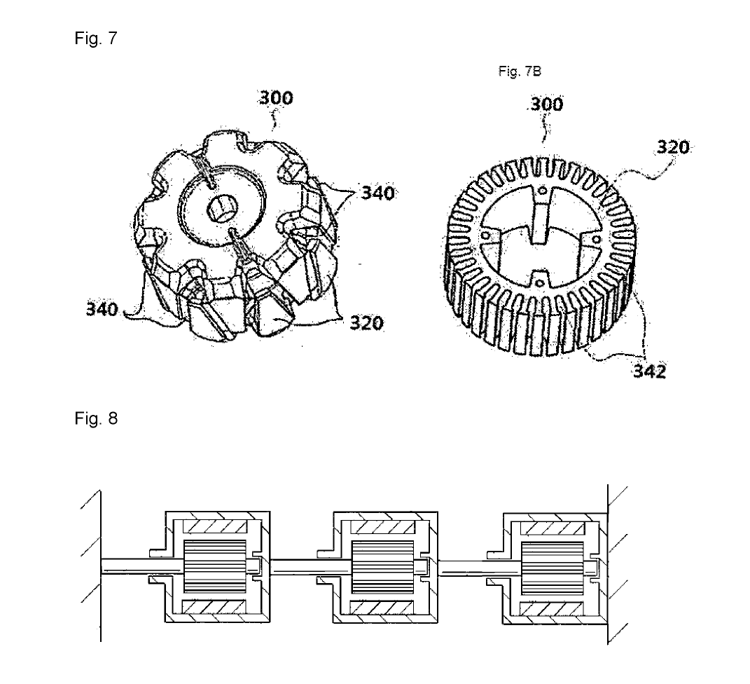

FIGS. 1 to 7 are views of the exterior and interior of the multiple alternating current generator according to the present invention, wherein FIG. 1 is a front view of the assembled exterior of the multiple alternating current generator, FIG. 2 is a cross-sectional view of the multiple alternating current generator, FIG. 3 is a view of an example of a plurality of rotating shafts of the multiple alternating current generator according to the present invention, FIG. 4 is a view of a polarity arrangement of rotators of the multiple alternating current generator according to the present invention, FIG. 5 is an external view of a coupling structure of a housing and intermediate support units of the multiple alternating current generator according to the present invention and a view of a structure of the housing that vertically opens, FIG. 6 is an example view of separated intermediate support units inside the multiple alternating current generator, and FIG. 7 is an example view of a shape of a rotator metal core.

Here, for convenience, the following descriptions will be made with a right side portion in FIGS. 1 to 7 where a pulley 560 is attached designated as a front side of the multiple alternating current generator and a left side portion designated as a rear side of the multiple alternating current generator.

As illustrated in the drawings, the multiple alternating current generator according to the present invention includes a rotating shaft, a plurality of rotators coupled to the rotating shaft about the rotating shaft to allow rotating with the rotating shaft; a plurality of stators formed in a cylindrical shape surrounding the rotator, having an inner circumferential surface on which a plurality of coil windings are formed, and having an outer circumferential surface coupled to a housing, the housing in a cylindrical shape that includes a plurality of stator coupling grooves configured to arrange a plurality of stators therein, and intermediate support unit grooves configured to arrange a plurality of intermediate support units, wherein the housing includes bearings configured to support the rotating shaft at both sides, and intermediate support units coupled to the intermediate support unit grooves and having bearings that support the rotating shafts between the plurality of rotators.

That is, the multiple alternating current generator according to the present invention includes a rotating shaft 500, rotators 300, stators 200, a housing 100, and intermediate support units 400.

For this, as an embodiment of the multiple alternating current generator, FIG. 1 shows an exterior view of a cylindrically shaped multiple alternating current generator formed due to coupling of a semi-cylindrical upper housing 100A and a lower housing 100B and having three generator units therein. On the outside of the lower housing 100B, a plurality of brackets 170 are integrally formed, and an AC output terminal 700 and a voltage supply unit 600, etc. are attached thereto.

In an inside structure of the housing 100, as illustrated in FIGS. 5 and 6, three stator coupling grooves 120 in which a stator metal core 210 may be coupled for stably supporting position are formed, and two intermediate support unit grooves 130 in which the intermediate support units 400 that support the rotating shaft 500 between the stator metal core 400 and the rotator 300 are formed. The stator coupling grooves 120 and the intermediate support unit grooves 130 change depending on the number of generators units.

While the stator coupling grooves 120 and the intermediate support unit grooves 130 are described as grooves, the stator coupling grooves 120 and the intermediate support unit grooves 130 may be formed as steps to support a stators 200 and the intermediate support units 400. An outer circumferential surface and sides in the front and rear of the semi-cylindrical upper housing 100A and the semi-cylindrical lower housing 100B are provided with a plurality of vents for discharging heat generated inside the generator, and a structure in which air is forced to circulate from a front vent 184 to a rear vent 186 by a rotator fan 360 attached to the rotator 300 is formed. Although 24 outer circumferential surface vents 182 and 24 front vents 184 are formed and 4 rear vents 186 are formed in the embodiment, the number of vents may readily be selected depending on the size of the generator. Also, at a portion where the upper housing 100A and lower housing 100B are coupled, a plurality of housing assembly bolt holes 190 are provided through which housing assembly nuts 194 and housing assembly bolts 192 couple the upper housing 100A and the lower housing 100B.

FIG. 2 is a vertical cross-sectional view of the multiple alternating current generator of FIG. 1 that shows a cross-sectional structure with a rotating shaft 500, which is made as a single shaft, passing through a central axis of the housing 100 formed by coupling the upper housing 100A and the lower housing 100B, three rotators 300 that are coupled to the rotating shaft 500, and three stators 200 are placed around the three rotators 300. On both sides of each of the rotators, rotator fans 360 are provided for discharging heat generated inside the generator, and positions of the rotator fans 360 coincide with positions of outer circumferential surface vents 180 formed on an outer circumferential surface of the housing 100 to maximize the cooling effect.

On both sides of housing 100, a front bearing support unit 152 and a rear bearing support unit 162 that have a U shape and fix a front bearing 112 and a rear bearing 114 are provided, and between the three rotators 300, two intermediate support units 400 that each support two intermediate bearings 420 are provided so that the rotators rotate stably and smoothly. A current supplied by a power control unit 600 that is fixed on an outer surface of a rear side of the housing by assembly bolts is supplied to each rotator coil 320 in parallel through rotator wires 520 each inserted in a brush 630, a slip ring 640, and a rotator wire groove 210 of the rotating shaft 100. Also, the power control unit 600 is an apparatus for supplying a current to the rotator 300 that supplies the current through a rectifier or a battery and includes the brush 630, the slip ring 640, an IC regulator 610, and a rotator input terminal 650.

Also, AC output terminals 700 are attached to an outer circumferential surface of the lower housing 100B for outputting a voltage generated from the stator coil 200 of each generator to the outside when each rotator rotates. The output voltages are used in parallel when the voltage generated through each stator coil is identical or are output to be different so as to be selected and used according to a load voltage.

The multiple alternating current generator of the present invention supplies a current to three rotators to form magnetic flux and rotates the integrated rotators by the pulley 560 to generate electromotive force in the stator coil to generate electricity. Here, a DC voltage supplied from a battery outside of the generator is supplied to the three rotators as a current in parallel through a voltage adjustment apparatus 620 and the rotator input terminal 650, and the magnetic flux generated from the three rotators 300 is guided to the stator coil 220 to generate electricity. As shown in FIG. 2, the rotating shaft 500 is provided with two rotator wire grooves 510 in which the rotator wires 520 capable of supplying an excitation current to the plurality of rotators 300 are inserted in a length direction of the rotating shaft. The rotator wire 520 is sheathed in a material including an epoxy, etc. and is pressed into the rotator wire groove 510 or wrapped by an insulating material formed integrally with the rotating shaft 500, and the insulating material is placed in the rotator wire groove 510 to insulate the rotating shaft 500. Here, for stable rotation of the rotating shaft 500, the two rotator wire grooves 510 are configured to be 180 degrees apart from each other about the rotating shaft 500 and are molded after inserting the rotator wire 520 to prevent separation due to centrifugal force.

The rotator wire 520 is supplied with an externally supplied current from a battery, etc. through a slip ring 640 and supplies the current through lead soldered parallel connections to each of the rotator coils 320. The configuration of the present invention has advantages of reducing manufacturing cost due to being able to supply a current to a plurality of rotators with a single group of slip rings rather than using a slip ring for each rotator and reducing loss due to being able to reduce friction compared to using a plurality of slip rings.

The rotating shaft, bearing, pulley, methods of coupling for pulley support ring and coupling rotators, and a method of winding a stator coil are conventionally known technologies, and thus descriptions thereof will be omitted.

FIG. 3 shows one embodiment in which assembly is facilitated by configuring the rotating shaft 500 that is configured as a single shaft in FIG. 2 into a plurality of connected shafts. That is, the rotating shaft 500 configured as one shaft in FIG. 2 is divided into three shafts which are a front rotating shaft 502, an intermediate rotating shaft 504, and a rear rotating shaft 506, and both ends of a rotating shaft are inserted into pipe-shaped rotating shaft coupling members 530 and coupled with headless bolts 540. Here, the number of the rotating shafts may be 2 or more according to the ease of assembly or maintenance so as to prevent the rotating shaft from moving forward or backward without using additional parts by providing a rotating shaft step 570 between a front bearing and a front rotator.

FIG. 4 is a view for describing the polarity arrangement of the rotator in which a front rotator winding direction is determined such that the magnetic field is formed in a direction from the rear side to the front side, and the same polarity of an adjacent rotator is symmetrically arranged with respect to the intermediate support unit 400 so that magnetic flux is not cancelled.

FIG. 5 shows that the housing 100 of the present invention is divided into the upper housing 100A and the lower housing 100B that make up upper and lower housing portions. Whereas a conventional generator coupled a stator and a rotator inside a cylindrical housing and thus has difficulties with assembling or disassembling from either side, the present invention forms a cylindrical housing by coupling semi-cylindrical housings vertically such that the upper housing 100A may be opened upward and thus has convenient assembly or maintenance.

FIG. 6 shows a structure in which the intermediate support unit 400 inside the housing in FIG. 5 is separated. Conventionally, the intermediate support unit 400 and the housing 100 are integrally formed, thus causing difficulties and high manufacturing cost when using a casting method such as a die casting method, etc. The present invention maximizes facility in manufacturing and assembly by enabling detachment of the intermediate support unit 400 from the housing 100. The coupled structure is achieved by providing grooves or steps on the inner circumferential surface of the housing, into which the intermediate support unit 400 may be inserted.

FIG. 7 shows a form of the rotator metal core used in the multiple alternating current generator of the present invention. The winding of the rotator coil may use one of the winding method in which a coil is perpendicular to the rotating shaft due to coupling the rotator metal core from both sides of a rotator coil bobbin on which the coil is wound on a cylindrical bobbin as shown in FIG. 7A and the winding method in which a coil is parallel to the rotating shaft due to winding a coil in a slot formed in the same direction as the rotating shaft on the outside of a cylindrical rotator metal core as shown in FIG. 7B. The method selected and used at manufacturing depends on the intended use of the generator, etc.

### INDUSTRIAL APPLICABILITY

The configuration of the present invention can reduce manufacturing cost by using a single group of slip rings to supply a current to a plurality of rotators rather than using a slip ring for each rotator and reduce loss by reducing friction relative to using a plurality of slip rings.

One of a winding method in which a coil is perpendicular to a rotating shaft due to coupling a rotator metal core from both sides of a rotator coil bobbin on which the coil is wound on a cylindrical bobbin and a winding method in which a coil is parallel to a rotating shaft due to winding a coil on a slot formed in the same direction as the rotating shaft on the outside of a cylindrical rotator metal core as shown in FIG. 7B can be selected and used at manufacturing depending on the intended use of the generator, etc.

1. A multiple alternating current generator comprising:
a rotating shaft;
a plurality of rotators coupled to the rotating shaft about the rotating shaft to allow rotating with the rotating shaft;
a plurality of stators formed in a cylindrical shape surrounding each of the rotators, having an inner circumferential surface on which a plurality of coil windings are formed, and having an outer circumferential surface coupled to a housing;
the housing in a cylindrical shape provided with a plurality of stator coupling grooves configured to arrange a plurality of stators therein, and intermediate support unit grooves configured to arrange a plurality of intermediate support units, wherein the housing includes bearings configured to support the rotating shaft at both sides;
intermediate support units coupled to the intermediate support unit grooves and having bearings that support the rotating shaft between the plurality of rotators.

2. The multiple alternating current generator of claim 1, wherein the housing in the cylindrical shape is separated into lower and upper housings with a semi-cylindrical shape and configured to be openable upward.

3. The multiple alternating current generator of claim 1, wherein the intermediate support unit grooves are positioned in the middle between the stator coupling grooves and are formed as grooves or steps.

4. The multiple alternating current generator of claim 1, wherein the intermediate support units are coupled to the intermediate support unit grooves and support each of the bearings that support the rotating shaft between the plurality of rotators, and one or multiple intermediate support units are provided.

5. The multiple alternating current generator of claim 1, wherein the rotating shaft has a rotator wire groove for providing a voltage to the plurality of rotators in parallel.

6. The multiple alternating current generator of claim 1, wherein the rotating shaft is provided as one or multiple rotating shafts.

7. The multiple alternating current generator of claim 6, wherein the multiple rotating shafts are connected by rotating shaft connection members and coupled with headless bolts.

8. The multiple alternating current generator of claim 6, wherein the rotating shaft has a step between a front bearing and a front rotator.

9. The multiple alternating current generator of claim 1, wherein the housing is provided with a front bearing support unit and a rear bearing support unit that have a U shape so that the bearings in a coupled state, which support the rotating shaft, is stably supported to prevent the bearings from moving forward or backward.

10. The multiple alternating current generator of claim 2, wherein a boundary surface in which the upper and lower housings are coupled is provided with a plurality of housing assembly bolt holes through which a plurality of housing assembly bolts are coupled with housing assembly nuts.

11. The multiple alternating current generator of claim 5, wherein the rotator wire grooves are provided as a pair at two angular positions which are 180 degrees apart from each other.

12. The multiple alternating current generator of claim 11, wherein a rotator wire is wired in the rotator wire groove and buried by molding or the like, and splits into a plurality of wires at a rotator input terminal or splits at the rotating shaft to which each of the rotators is coupled to supply a current to the rotators in parallel.

13. The multiple alternating current generator of claim 12, wherein the rotator input terminal of the rotating shaft receives a current from the outside in a manner in which the current is supplied to the rotator input terminal through a brush and a slip ring from the rear of the rotating shaft.

14. The multiple alternating current generator of claim 1, wherein the rotator receives a current in a manner in which an external rectifier or a battery is used or a voltage regulated by a rectifier of a power supply, a voltage regulator, or an IC regulator is supplied when a voltage develops at an output terminal of the rotator due to rotation of the rotator due to initially receiving a current from an external battery.

15. The multiple alternating current generator of claim 1, wherein the voltages generated through coils of the plurality of stator are identical to each other and used in parallel or output to be different so as to be selected and used according to a load voltage.

16. The multiple alternating current generator of claim 1, wherein the multiple alternating current generator controls generator units, each of which includes the rotator and the stator, depending on the magnitude of power delivered to the rotating shaft.

17. The multiple alternating current generator of claim 1, wherein a size and power generation capacity of the generator is made to be medium or large, depending on installation space and power delivered to the rotating shaft of the multiple alternating current generator.

18. The multiple alternating current generator of claim 1, wherein the plurality of rotators are arranged such that the same poles in the adjacent rotors are symmetrically arranged to prevent cancelling of magnetic flux between the adjacent rotators.

19. The multiple alternating current generator of claim 1, wherein the rotator has fans on both sides and the attached fans induce air to flow from the front to the rear of the generator and be discharged from the housing.

20. The multiple alternating current generator of claim 2, wherein the lower housing has a plurality of fastening brackets.

21. The multiple alternating current generator of claim 1, wherein a coil winding direction of the rotator is determined by one of a method in which winding is perpendicular to the rotator shaft or a method in which winding is parallel to the rotator shaft.

22. The multiple alternating current generator of claim 1, wherein a plurality of vents are provided at an outer circumferential surface and ends of both sides.

23. The multiple alternating current generator of claim 1, wherein the stator coupling groove has a structure having a groove or a step.
